(19) United States
(12) Patent Application Publication
(10) Pub. No.: US 2018/0112066 A1
(43) Pub. Date: Apr. 26, 2018

(54) 3-GLYCIDYLOXYPROPYLTRIALKOXYSILANES HAVING LONG-CHAIN ALKOXY GROUPS, PROCESSES FOR PRODUCTION AND USE

(71) Applicant: Evonik Degussa GmbH, Essen (DE)

(72) Inventors: Roland Krafczyk, Rheinfelden (DE); Alexander Koepfer, Bernau im Schwarzwald (DE); Sebastian Rosenstingl, Rheinfelden (DE)

(73) Assignee: Evonik Degussa GmbH, Essen (DE)

(21) Appl. No.: 15/791,111

(22) Filed: Oct. 23, 2017

(30) Foreign Application Priority Data
Oct. 25, 2016 (EP) 16195474.8
May 30, 2017 (EP) 17173459.3

(51) Int. Cl. C08K 5/5415; C07F 7/02; B60C 1/00

(52) U.S. Cl. CPC C08K 5/5415; C08L 9/00; B60C 1/0016; C07F 7/025

(57) ABSTRACT

A novel compound, which is 3-glycidyloxypropyltri(-2-propylheptoxy)silane. A process for producing a 3-glycidyloxypropyltrialkoxysilane having long-chain alkoxy groups of formula (I)

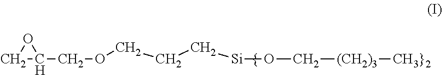

or
of formula (II)

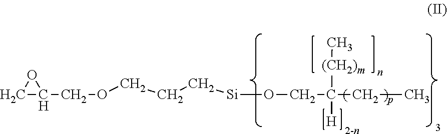

where m=1 or 2, n=0 or 1, p=3, 4, 5, 6, 7, 8, 9 or 10,
where the method includes heating 3-glycidyloxypropyltrimethoxysilane or 3-glycidyloxypropyltriethoxysilane, with a stoichiometric amount or an excess of a longer-chain alcohol from the group of the C5- to C16-alcohols, in the presence of titanium tetrabutoxide as catalyst, with stirring to a temperature of not more than 225° C., reacting, and then following the reaction by removing methanol/ethanol and excess reactant alcohol from the product mixture by distillation, optionally under reduced pressure. A method of using the 3-glycidyloxypropyltri(-2-propylheptoxy)silane for functionalization of rubber and using the rubber in treads for reducing rolling resistance in tires.

### CROSS REFERENCE TO RELATED APPLICATIONS

This application claims foreign priority to European patent applications 16195474.8 filed Oct. 25, 2016 and 17173459.3 filed May 30, 2017, the entirety of which are incorporated herein by reference.

### BACKGROUND OF THE INVENTION

### Field of the Invention

The present invention relates to novel 3-glycidyloxypropyltrialkoxysilanes having selected long-chain alkoxy radicals, to a special process for the production thereof and to the use thereof.

### Description of the Related Art

EP 0773231 describes polymers functionalized using 3-glycidyloxypropyltrialkoxysilanes. When these polymers are employed in mixtures for tyre treads, the rolling resistance of tyres can be reduced. These functionalized polymers are produced using 3-glycidyloxypropyltrialkoxysilanes for chain termination of the anionic polymerization. The reaction liberates inter alia the corresponding alcohol. When as described in EP 0773231 the product 3-glycidyloxypropyltrimethoxysilane (Dynasylan® GLYMO) is employed, methanol is correspondingly liberated. Since anionic polymerizations are performed in an inert solvent, for example n-hexane or cyclohexane, the alcohol liberated during chain termination must be removed from the solvent since upon reuse of the solvent the alcohol would likewise terminate the polymerization. Furthermore, methanol has a similar boiling point to the solvent n-hexane or cyclohexane and can therefore be removed to make the solvent usable again only with great difficulty/at great distillation cost and complexity.

Transesterification reactions as such are well-known, inter alia for alkoxysilanes. An acid is usually used as the transesterification catalyst.

DE-B 1010739 teaches the production of polysilicic esters by reaction of tetraethoxysilane with higher alcohols such as cyclohexanol, methylcyclohexanol and phenols in the presence of an anhydrous or aqueous carboxylic acid as condensing agent, for example acetic or formic acid. The volatile compounds formed in the reaction, such as lower alcohol, were distilled off. The product is acid-containing.

U.S. Pat. No. 2,846,459 discloses production of brominated alkyl silicates by transesterification, wherein the examples proceeded from ethyl polysilicate and the latter was reacted, inter alia, with a mixture of 2,3-dibromopropan-1-ol and 2-ethylhexanol. Catalysts used here were sodium ethoxide or a mixture of sodium methoxide and potassium carbonate. Here too, the compounds that were still volatile after the reaction, such as lower alcohol, were distilled off and hence corresponding brominated alkyl silicates were obtained.

Example 7 of EP1035184A1 discloses the reaction of 100 g of ethyl silicate with 18 g of 2-ethylhexanol in the presence of sulphuric acid as catalyst. The reaction was effected over 1 hour at 120° C. Any volatile constituents still present afterwards were distilled off. This afforded an alkyl silicate that still had a content of 94 mol % of ethyl and a molecular weight of 1750 g/mol. Only partial transesterification was effected here with a low yield, and the product, furthermore, is acidic because of the residual amount of sulphuric acid used and remaining in the product. Further processing of the product was carried out in THF.

The compound 2-[[3-[tris(pentyloxy)silyl]propoxy]methyl]]oxirane is mentioned in JP S62 199612 A.

2-[[3-[tris(pentyloxy)silyl]propoxy]methyl]]oxirane is further discernible from DE 33 14 552A1.

3-Glycidyloxypropyltrialkoxysilanes having long-chain alkoxy radicals as such are thus virtually undescribed.

The glycidyloxy group in 3-glycidyloxypropyltrimethoxysilane and 3-glycidyloxypropyltriethoxysilane is a very reactive group, for example toward nucleophilic compounds and in particular in the presence of an acid.

### SUMMARY OF THE INVENTION

The present invention accordingly had for its object the provision of 3-glycidyloxypropyltrialkoxysilanes having long-chain alkoxy radicals and compositions comprising a high proportion of 3-glycidyloxypropyltrialkoxysilane having long-chain alkoxy radicals, including a suitable production process and optionally also a suitable possible application for corresponding products. Particular objectives included finding a nonacidic catalyst for a transesterification and thus achieving the highest possible product yield while retaining the glycidyloxy group. It was also sought to avoid the abovementioned disadvantages wherever possible or at least reduce them.

The stated object is advantageously achieved by the invention according to the features in the present claims.

In addition it is explicitly noted that all of the features, preferred ranges and cross-references to further documents described below are each combinable with one another and are accordingly disclosed in their entirety and incorporated into the present disclosure.

A special process for the production of 3-glycidyloxypropyltrialkoxysilanes having long-chain alkoxy radicals, i.e. those having more than 4 carbon atoms in the carbon chain of the alkoxy group, in particular of 3-glycidyloxypropyltri(-2-ethylhexoxy)silane and 3-glycidyloxypropyltri(-2-propylheptoxy)silane, has surprisingly now been found, where 3-glycidyloxypropyltrimethoxysilane or 3-glycidyloxypropyltriethoxysilan, a defined amount of a C5- to C16-alcohol, preferably C6- to C12-alcohol, particularly preferably C7- to C11-alcohol, most particularly preferably from the group of linear or branched C8- to C9- or C10-alcohols, preferably also those having an OH group in the co-position, in particular 2-ethylhexanol or 2-propylheptanol, and a defined catalytic amount of titanium tetrabutoxide are brought together, the reactant mixture is heated with stirring to a temperature of ≤225° C. at 1 bar (atmospheric pressure), preferably to a temperature of 100-220° C., reacted and, following the reaction, methanol/ethanol and any excess long-chain alcohol present, such as 2-ethylhexanol/2-propylheptanol, are removed from the thus obtained product mixture by distillation, preferably by fractional distillation under reduced pressure, to obtain the target product/the product composition according to the invention as bottoms product in exceptional yield after distillation.

Furthermore, the composition according to the invention is not acidic and advantageously contains a content of a target compound according to the invention, in particular 3-glycidyloxypropyltri(-2-ethylhexoxy)silane/3-glycidyloxypropyltri(-2-propylheptoxy)silane, of ≥90% by weight, and a content of free methanol/ethanol of ≤1% by weight, in each case based on the product/the product composition.

The produced novel 3-glycidyloxypropyltrialkoxysilanes having long-chain alkoxy radicals, in particular 3-glycidyloxypropyltri(-2-ethylhexoxy)silane/3-glycidyloxypropyltri(-2-propylheptoxy)silane, may advantageously be used for terminal functionalization of solution styrene-butadiene rubber (S-SBR) and butadiene rubber (BR) during anionic polymerization and may then be readily removed from the employed solvent, such as n-hexane or cyclohexane, in order that the solvent may be reused. Moreover, rubber mixtures for tyre treads comprising a rubber functionalized with 3-glycidyloxypropyltrialkoxysilanes having long-chain alkoxy radicals feature the particular advantage that they bring about a reduction in rolling resistance of the tyres.

The present invention accordingly provides the compound 3-glycidyloxypropyltri(-2-propylheptoxy)silane per se.

The invention further provides a process for producing a 3-glycidyloxypropyltrialkoxysilane having long-chain alkoxy groups of general formula (I)

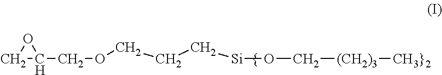

or

of general formula (II)

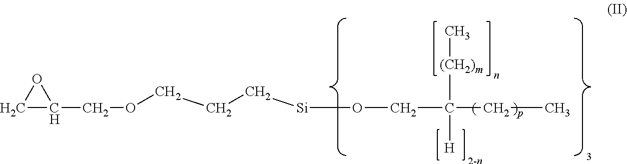

with m=1 or 2, n=0 or 1, p=3, 4, 5, 6, 7, 8, 9 or 10, in particular 3-glycidyloxypropyltri(-2-ethylhexoxy)silane and 3-glycidyloxypropyltri(-2-propylheptoxy)silane,

where
3-glycidyloxypropyltrimethoxysilane or 3-glycidyloxypropyltriethoxysilane, with a stoichiometric amount or an excess of a longer-chain alcohol from the group of the C5- to C16-alcohols,
in the presence of titanium tetrabutoxide as catalyst,
is heated with stirring to a temperature of not more than 225° C.,
reacted, and
following the reaction, methanol/ethanol and excess reactant alcohol, are removed from the product mixture by distillation, preferably under reduced pressure, and the product is obtained.

The general formula (II) can also optionally be illustrated as follows:

O

[H₂C‘-’CH]CH₂—O—(CH₂)₃—Si{—OCH₂C(H)₂₋ₙ[(CH₂)ₘCH₃]ₙ(CH₂)ₚCH₃}₃

In the process according to the invention it is preferable to employ as the long-chain alcohol 2-ethylhexan-1-ol, isononanol or 2-propylheptan-1-ol, with isononanol, also referred to as isononan-1-ol or 1-isononanol, essentially representing the isomers or isomer mixtures thereof, inter alia 3,5,5-trimethyl-1-hexanol, isomeric dimethyl-1-heptanols, 7-methyloctan-1-ol, to name but a few.

In the process according to the invention it is advantageous to employ 3-glycidyloxypropyltrimethoxysilane or 3-glycidyloxypropyltriethoxysilane and the long-chain alcohol, in particular 2-ethylhexanol and 2-propylheptanol, in a molar ratio of 1:3 to 6, preferably 1:3 to 5, particularly preferably 1:3.0 to 4, in particular 1:3.0 to 3.9. If purities >95% are required, the long-chain alcohol may advantageously be employed stoichiometrically in a molar ratio of 3-glycidyloxypropyltrimethoxysilane or 3-glycidyloxypropyltriethoxysilane to long-chain alcohol of 1:3.0.

In the process according to the invention it is moreover advantageous to employ 0.01 to 0.5% by weight, preferably from 0.05% to 0.2% by weight and particularly preferably 0.1% by weight of titanium tetrabutoxide based on the employed amount of 3-glycidyloxypropyltrimethoxysilane/glycidyloxypropyltriethoxysilane.

In the process according to the invention the reaction is suitably performed at a temperature of 100 to 220° C., preferably of 120 to 150° C., particularly preferably of 120 to 140° C., and over a period of 6 to 24 hours, preferably of 9 to 18 hours.

### DETAILED DESCRIPTION OF THE INVENTION

The process according to the invention is generally performed as follows:

Generally a mixture of for example 3-gycidyloxypropyltrimethoxysilane and a stoichiometric amount to relative excess by molecular weight of 2-ethylhexanol or 2-propylheptanol and also a catalytic amount of titanium tetrabutoxide are initially charged into a suitable reaction apparatus—for example based on a reaction vessel having feeds for reactant metering, stirrer, heating means, temperature control/regulation, reflux condenser and bridge with receiver—, the mixture is heated with stirring preferably to a temperature of 100 to 220° C., in particular to a temperature in the range from 120 to 140° C., the mixture is reacted at this temperature for a sufficiently long period, preferably over 6 to 24 hours, and then following the reaction phase the volatile components still present in the reaction mixture/product mixture thus obtained, such as methanol/ethanol, and any excess long-chain alcohol, such as 2-ethylhexanol/2-propylheptanol, are suitably distilled off under reduced pressure to work up the reaction mixture/product mixture by means of distillation and hence obtain the product/product mixture. For example, to perform the distillation, the reaction mixture/product mixture present after reaction may be transferred from the reaction vessel into a separate distillation unit and worked up by fractional distillation. It is also possible to apply a vacuum during distillation, i.e. to distil under reduced pressure, and facultatively also to pass nitrogen through the product/product mixture present in the bottom of the distillation apparatus. The product/the composition according to the invention is thus advantageously obtained as a colourless to yellowish, slightly viscous liquid in the bottom of the distillation apparatus used. Alternatively, the volatile alcohols, such as methanol/ethanol and the excess long-chain alcohols, may be gently removed under vacuum using a thin-film evaporator from the product/product mixture which is advantageously collected as so-called “high boiler”.

Surprisingly, performing the process according to the invention achieves in particularly advantageous fashion virtually complete transesterification with a yield of ≥90%, in particular ≥95%, and thus makes it possible, to great advantage, to provide a corresponding novel reaction product. It is thus possible by the process according to the invention advantageously to obtain novel 3-glycidyloxypropyltrialkoxysilanes having long-chain alkoxy groups according to formula (I) and formula (II) and corresponding compositions having a high content of corresponding 3-glycidyloxypropyltrialkoxysilanes having long-chain alkoxy groups, in particular of 3-glycidyloxypropyltri(-2-ethylhexoxy)silane and 3-glycidyloxypropyltri(-2-propylheptoxy)silane, of ≥90% by weight, preferably ≥95% by weight.

The present invention therefore also provides compositions having a content of 3-glycidyloxypropyltri(-2-ethylhexoxy)silane/3-glycidyloxypropyltri(-2-propylheptoxy)silane of ≥90% by weight, preferably ≥95% by weight, which are obtainable by the process according to the invention, wherein the components in the composition sum to 100% by weight.

The invention further provides a composition/a composition produced according to the invention having a content of 3-glycidyloxypropyltri(-2-ethylhexoxy)silane/3-glycidyloxypropyltri(-2-propylheptoxy)silane of ≥90% by weight, preferably ≥95% by weight, based on the composition.

A composition according to the invention/a composition produced according to the invention preferably furthermore has a content of methanol/ethanol of ≤1% by weight, preferably from ≤0.5% by weight down to the detection limit, based on the composition, and thus also features, also from an environmental standpoint only, a very low proportion of VOCs (volatile organic compounds). Compositions according to the invention/compositions produced according to the invention may also comprise a content of so-called mixed esters, preferably—but not exclusively—from the group of 3-glycidyloxypropyldi(-2-ethylhexoxy)monomethoxysilane, 3-glycidyloxypropyldi(-2-ethylhexoxy)monoethoxysilane, 3-glycidyloxypropylmono(-2-ethylhexoxy)dimethoxysilane and 3-glycidyloxypropylmono(-2-ethylhexoxy)diethoxysilane, suitably with a content of mixed ester of ≤10% by weight, preferably ≤5% by weight, wherein all components in a composition according to the invention/compositions produced according to the invention sum to 100% by weight.

The present invention further provides for the use of at least one of the 3-glycidyloxypropyltrialkoxysilanes according to the invention having long-chain alkoxy groups according to formula (I) and formula (II), in particular glycidyloxypropyltri(-2-ethylhexoxy)silane or 3-glycidyloxypropyltri(-2-propylheptoxy)silane, for functionalization of rubber, wherein the 3-glycidyloxypropyltrialkoxysilane having long-chain alkoxy groups, in particular 3-glycidyloxypropyltri(-2-ethylhexoxy)silane or 3-glycidyloxypropyltri(-2-propylheptoxy)silane, is preferably used for chain termination in an anionic polymerization. It is preferable to employ at least one of the recited 3-glycidyloxypropyltrialkoxysilanes having long-chain alkoxy groups for functionalization/modification of rubber.

It is furthermore advantageous to use a rubber modified with at least one 3-glycidyloxypropyltrialkoxysilane having long-chain alkoxy groups of formula (I) and of formula (II), preferably 3-glycidyloxypropyltri(-2-ethylhexoxy)silane or 3-glycidyloxypropyltri(-2-propylheptoxy)silane, in rubber mixtures; in particular an S-SBR or BR modified with 3-glycidyloxypropyltri(-2-ethylhexoxy)silane or 3-glycidyloxypropyltri(-2-propylheptoxy)silane in rubber mixtures for treads in tyres.

The novel compounds/compositions according to the invention may thus be employed in advantageous fashion for example—but not exclusively—as a coupling reagent in the production of functional polymers, such as butadiene rubber, or for solution styrene-butadiene rubber.

The present invention is elucidated in detail by the examples which follow, without restricting the subject-matter of the invention:

Having generally described this invention, a further understanding can be obtained by reference to certain specific examples which are provided herein for purposes of illustration only, and are not intended to be limiting unless otherwise specified.

### EXAMPLES

Chemicals Used:

Dynasylan® GLYMO (3-glycidyloxypropyltrimethoxysilane), Evonik Resource Efficiency GmbH

Titanium tetrabutoxide, Sigma-Aldrich

2-ethylhexanol, Sigma-Aldrich

2-propylheptanol, Evonik Performance Materials GmbH

Analytical Methods:

NMR Measurements:

Instrument: Bruker

Frequency: 100.6 MHz (¹³C-NMR)

Scans: 1024 (¹³C-NMR)

Temperature: 296 K

Solvent: CDCl₃

Standard: tetramethylsilane

Gas Chromatography Determination of Alcohol:

All figures should be understood as guide values. Columns of similar polarity, for example from other manufacturers, are permitted. If the separation is demonstrably also achievable with an instrument having a packed column, this is also permitted.

In the handling of the samples, the moisture sensitivity thereof should be noted.

| Instrument: | Capillary gas chromatograph with TCD and | |
|---|---|---|
| | integrator e.g. HP 5890 with HP 3396 integrator | |
| Separation column: | Capillary column | |
| | Length: | 25 m |
| | Internal diameter: | 0.20 mm |
| | Film thickness: | 0.33 mm |
| | Stationary phase: | HP Ultra 1 |
| Temperatures: | Column oven: | 120° C. - 2 min - 10°/min - |
| | | 275° C. - 8 min |
| | injector: | 250° C. |
| | Detector: | 280° C. |
| Carrier gas: | Helium | |
| | Flow: | about 1 ml/min |
| | Split ratio: | ca. 1:100 |

| | |
|---|---|
| Sample injected: | 0.4 ml |

Evaluation is effected by standardization to 100 area %.

### Example 1

Dynasylan® GLYMO (23.6 g, 100 mmol, 1.0 eq.), 2-ethylhexanol (39.1 g, 300 mmol, 3.0 eq.) and Ti(OnBu)₄ (23.6 mg, 0.1% by weight based on Dynasylan® GLYMO) were initially charged and heated to 130° C. for 12 h. The product was then separated from volatile constituents at 130° C. and 0.1 mbar. The reaction product obtained (56.1 g) was a pale yellowish, slightly viscous liquid.

The reaction product was analysed by means of ¹³C NMR. The analysis demonstrates that the reaction product obtained was a 3-glycidyloxypropyltri(-2-ethylhexoxy)silane.

¹³C-NMR (100 MHz, CDCl₃): δ=74.0 (s, 1C), 71.5 (s, 1C), 64.9 (s, 3C), 50.9 (s, 1C), 44.4 (s, 1C), 41.9 (s, 3C), 30.2 (s, 3C), 29.2 (s, 3C), 23.5 (s, 3C), 23.2 (s, 3C), 14.1 (s, 3C), 11.2 (s, 3C), 6.4 (s, 1C) ppm.

The transesterification yield was 95%, i.e. 95% of the methoxy groups of the employed Dynasylan® GLYMO were replaced, i.e. transesterified, with 2-ethylhexoxy groups in accordance with the invention.

### Example 2

Dynasylan® GLYMO (23.6 g, 100 mmol, 1.0 eq.), 2-ethylhexanol (50.1 g, 390 mmol, 3.9 eq.) and Ti(OnBu)₄ (23.6 mg, 0.1% by weight based on Dynasylan® GLYMO) were initially charged and heated to 130° C. for 16 h. The product was then separated from volatile constituents at 130° C. and 0.1 mbar. The reaction product obtained (57.9 g) was a pale yellowish, slightly viscous liquid.

The reaction product was analysed by means of ¹³C NMR. The analysis demonstrates that the reaction product obtained was a 3-glycidyloxypropyltri(-2-ethylhexoxy)silane.

¹³C-NMR (100 MHz, CDCl₃): δ=74.0 (s, 1C), 71.5 (s, 1C), 64.9 (s, 3C), 50.9 (s, 1C), 44.4 (s, 1C), 41.9 (s, 3C), 30.2 (s, 3C), 29.2 (s, 3C), 23.5 (s, 3C), 23.2 (s, 3C), 14.1 (s, 3C), 11.2 (s, 3C), 6.4 (s, 1C) ppm.

The transesterification yield was 98%, i.e. 98% of the methoxy groups of the employed Dynasylan® GLYMO were replaced, i.e. transesterified, with 2-ethylhexoxy groups in accordance with the invention.

### Example 3

Dynasylan® GLYMO (23.6 g, 100 mmol, 1.0 eq.), 2-propylheptanol (47.5 g, 300 mmol, 3.0 eq.) and Ti(OnBu)₄ (23.6 mg, 0.1% by weight based on Dynasylan® GLYMO) were initially charged and heated to 130° C. for 12 h. The product was then separated from volatile constituents at 130° C. and 0.1 mbar. The reaction product obtained (59.0 g) was a pale yellowish, slightly viscous liquid.

The reaction product was analysed by means of ¹³C NMR The analysis demonstrates that the reaction product obtained was a 3-glycidyloxypropyltri(-2-propylheptoxy)silane.

¹³C-NMR (100 MHz, CDCl₃): δ=73.9 (s, 1C), 71.4 (s, 1C), 65.3 (s, 3C), 50.9 (s, 1C), 44.3 (s, 1C), 40.2 (s, 3C), 33.4 (s, 3C), 32.5 (s, 3C), 31.0 (s, 3C), 26.6 (s, 3C), 22.8 (s, 3C), 20.1 (s, 3C), 14.6 (s, 3C), 14.2 (s, 3C), 6.4 (s, 1C) ppm.

The transesterification yield was 96%, i.e. 96% of the methoxy groups of the employed Dynasylan® GLYMO were replaced, i.e. transesterified, with 2-propylheptoxy groups in accordance with the invention.

### Example 4

Dynasylan® GLYMO (23.6 g, 100 mmol, 1.0 eq.), 2-propylheptanol (61.7 g, 390 mmol, 3.9 eq.) and Ti(OnBu)₄ (23.6 mg, 0.1%6 by weight based on Dynasylan® GLYMO) were initially charged and heated to 130° C. for 18 h. The product was then separated from volatile constituents at 130° C. and 0.1 mbar. The reaction product obtained (60.9 g) was a pale yellowish, slightly viscous liquid.

The reaction product was analysed by means of ¹³C NMR. The analysis demonstrates that the reaction product obtained was a 3-glycidyloxypropyltri(-2-propylheptoxy)silane.

¹³C-NMR (100 MHz, CDCl₃): δ=73.9 (s, 1C), 71.4 (s, 1C), 65.3 (s, 3C), 50.9 (s, 1C), 44.3 (s, 1C), 40.2 (s, 3C), 33.4 (s, 3C), 32.5 (s, 3C), 31.0 (s, 3C), 26.6 (s, 3C), 22.8 (s, 3C), 20.1 (s, 3C), 14.6 (s, 3C), 14.2 (s, 3C), 6.4 (s, 1C) ppm.

The transesterification yield was 99%, i.e. 99% of the methoxy groups of the employed Dynasylan® GLYMO were replaced, i.e. transesterified, with 2-propylheptoxy groups in accordance with the invention.

Numerous modifications and variations on the present invention are possible in light of the above teachings. It is therefore to be understood that within the scope of the appended claims, the invention may be practiced otherwise than as specifically described herein.

1. A compound, wherein the compound is 3-glycidyloxypropyltri(-2-propylheptoxy)silane.

2. A process for producing a 3-glycidyloxypropyltrialkoxysilane having long-chain alkoxy groups of formula (I): 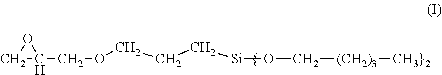
or
of formula (II) 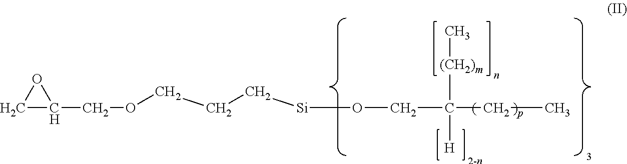
wherein m=1 or 2, n=0 or 1, p=3, 4, 5, 6, 7, 8, 9 or 10,
the process comprising:
heating 3-glycidyloxypropyltrimethoxysilane or 3-glycidyloxypropyltriethoxysilane, with a stoichiometric amount or an excess of a longer-chain alcohol from the group of the C5- to C16-alcohols, in the presence of titanium tetrabutoxide as catalyst, with stirring to a temperature of not more than 225° C.,
reacting to obtain a product mixture, and
after the reacting, removing methanol/ethanol and excess reactant alcohol from the product mixture by distillation, to obtain a product.

3. The process according to claim 2,
wherein the long-chain alcohol employed is 2-ethylhexan-1-ol, isononan-1-ol or 2-propylheptan-1-ol.

4. The process according to claim 2,
wherein glycidyloxypropyltrimethoxysilane or glycidyloxypropyltriethoxysilane and a long-chain alcohol, are employed in a molar ratio of 1:3 to 6.

5. The process according to claim 2,
wherein 0.01% to 0.5% by weight of titanium tetrabutoxide based on the employed amount of 3-glycidyloxypropyltrimethoxysilane is employed.

6. The process according to claim 2,
wherein the reaction is performed at a temperature of 100 to 220° C.

7. The process according to claim 2,
wherein the reaction is performed over a period of 6 to 24 hours.

8. The process according to claim 2,
wherein the transesterification is performed with a yield of ≥90%.

9. The process according to claim 2,
wherein a product is obtained as a composition having a content of 3-glycidyloxypropyltri(-2-ethylhexoxy)silane/3-glycidyloxypropyltri(-2-propylheptoxy)silane of ≥90% by weight, wherein the components in the composition sum to 100% by weight.

10. A composition, comprising a content of 3-glycidyloxypropyltri(-2-ethylhexoxy)silane or 3-glycidyloxypropyltri(-2-propylheptoxy)silane of ≥90% by weight obtained by the process according to claim 2, wherein the components in the composition sum to 100% by weight.

11. The composition according to claim 10, comprising a content of 3-glycidyloxypropyltri(-2-ethylhexoxy)silane or 3-glycidyloxypropyltri(-2-propylheptoxy)silane of ≥95%.

12. The composition according to claim 10, comprising a content of alcohols of methanol or ethanol of ≤1% by weight, based on the composition.

13. The composition according to claim 10, having a content of mixed esters ≤10% by weight, wherein the mixed esters are selected from the group consisting of 3-glycidyloxypropyldi(-2-ethylhexoxy)monomethoxysilane, 3-glycidyloxypropyldi(-2-ethylhexoxy)monoethoxysilane, 3-glycidyloxypropylmono(-2-ethylhexoxy)dimethoxysilane and 3-glycidyloxypropylmono(-2-ethylhexoxy)diethoxysilane.

14. A method of functionalizing rubber, comprising anionically polymerizing the rubber in the presence of the composition according to claim 10, wherein the 3-glycidyloxypropyltri(-2-ethylhexoxy)silane or 3-glycidyloxypropyltri(-2-propylheptoxy)silane is employed for chain termination.

15. A method, comprising modifying rubber with at least one 3-glycidyloxypropyltrialkoxysilane having long-chain alkoxy groups obtained by the process according to claim 2.

16. A rubber mixture, comprising a rubber modified with at least one 3-glycidyloxypropyltrialkyloxysilane having long-chain alkoxy groups obtained by the process according to claim 2.

17. The method according to claim 14, comprising applying a rubber mixture comprising a solution styrene-butadiene rubber (S-SBR) or butadiene rubber (BR) modified with the composition in treads of at least one tire.

18. The process according to claim 2, wherein the 3-glycidyloxypropyltrialkyloxysilane having long-chain alkoxy groups is 3-glycidyloxypropyltri(-2-ethylhexoxy)silane or 3-glycidyloxypropyltri(-2-propylheptoxy)silane.

19. The process according to claim 4, wherein the long-chain alcohol is 2-ethylhexanol or 2-propylheptanol.
